(19) United States
(12) Patent Application Publication
(10) Pub. No.: US 2025/0092709 A1
(43) Pub. Date: Mar. 20, 2025

(54) GROUND SUPPORT ASSEMBLY FOR TEMPORARY SHELTER SUPPORT STRUCTURES

(71) Applicant: Peggy Peg Innovative Systems GmbH, Neudrossenfeld (DE)

(72) Inventor: Achim Reinhold, Neudrossenfeld (DE)

(21) Appl. No.: 18/884,333

(22) Filed: Sep. 13, 2024

(30) Foreign Application Priority Data
Sep. 14, 2023 (GB) GB2314078.3

(51) Int. Cl. E04H 12/22; B60P 3/34; E04H 15/08; E04H 15/62

(52) U.S. Cl. CPC E04H 12/2238; B60P 3/343; E04H 12/2269; E04H 15/08; E04H 15/62

(57) ABSTRACT

The present invention provides for a ground support assembly for different pole structures, comprising: a substantially planar base member, extending between a first end portion and a second end portion along a longitudinal central axis and defining a top surface and a bottom surface, comprising a central support portion adapted to receive and support a predetermined range of different foot portions of different pole structures, and a locking mechanism, adapted to releasably secure a foot portion of the predetermined range of different foot portions of the pole structure, comprising a first jaw member and an axially opposing second jaw member, each one selectively slidably mounted to said top surface of said base member and adapted to move in a direction along said central longitudinal axis between a first position, moved towards and enclosingly engaging said central support portion in cooperation with the other one of said first and second jaw member, and a second position, moved away and enclosingly disengaged from said central support portion; wherein said second position is defined by a first and second stop member, each one operably coupled to said base member so as to stoppingly engage with a respective one of said first and second jaw member when moving from said first position towards said second position.

### TECHNICAL FIELD OF INVENTION

The present invention relates to support frames or support legs for temporary structures, such as, for example, camping shelters comprising awnings and tents. In particular, the present invention relates to a ground support assembly for support frames or support legs or poles, adapted to support and releasably secure foot portions of support frames,-legs and-poles to the ground.

### BACKGROUND

Awnings are simple tent-like structures typically made of canvas or other sheet material that can be attached to a vehicle, caravan or any other suitable structure. Typically, awnings are temporary structures that should be quick and easy not only to erect but also to dismantle. Whilst it is erected, assembled or deployed, an awning or other tent-like structure must be strong enough to withstand strong winds, as well as, heavy rain, i.e. the support frame and/or support legs have to be secured to the ground, so as to prevent any of the support legs or poles from slipping (e.g. on a hard ground) and/or sinking (e.g. on a soft ground). For example, pegs or screw-in pegs may be used to affix guylines to provide lateral support to the support legs, wherein support plates may be used to provide a stable surface on an uneven and/or soft ground.

Support plates for the awning's support frame or support legs are available in various styles and formats, including, for example, basic plates in order to simply provide support for the leg and prevent the leg or pole from sinking into the ground, or support plates configured to secure the foot of a support leg or pole using pegs or ground screws. Other embodiments of the ground plate may allow the foot of the support leg to be fixed, while the support plate comprises apertures for pegs or ground screws.

However, many of the ground support solutions for such frame structures or support legs are either inadequate in adverse weather conditions (e.g. the basic plates and support legs can be lifted by strong winds or slide in wet conditions), or too complex and cumbersome for a quick release and removal or assembly. Also, when using pegs and guylines, repeated removal of the pegs may cause substantial damage to the ground making it unsuitable for continued use.

Furthermore, today, many caravans are fitted with so called “rollout” awnings typically fitted onto the side or roof of a caravan or vehicle and configured to roll out from its roll, or pull out of its housing (in case it is enclosed in a housing), so as to provide a roof structure once connected to respective support legs or poles. These rollout awnings can be relatively sophisticated devices often including complex components, such as, motors or gear mechanisms in order to improve the ease of use, though, significantly increasing the overall weight and/or size. For that reason, a user may have to replace the support structures (legs or poles) in case of damage, or simply to provide a stronger support leg for a heavier awning. However, many of the available ground support plates are not compatible with support legs from other brands or of different sizes, thus, forcing the user to buy additional ground support plates.

There are many instances when a traveller may pull to the side of the road for a short break and in such instances the ease and time needed of erecting, as well as, removing the awning will determine, whether or not, it is deployed. However, the currently available ground support fixtures for support legs or poles are either too complex, requiring a substantial amount of time and effort to install, or too heavy and cumbersome, thus, making them unsuitable for quick assembly and release.

Accordingly, it is an object of the present invention to provide a simplified ground support assembly suitable for a variety of different support legs or poles and respective feet structures and with a modular simplicity, improving cost-effectiveness for manufacture and repair, as well as, durability and ease of use.

### SUMMARY OF THE INVENTION

Aspects of the invention are set out in the independent claim(s). Dependent claims describe optional features.

According to an aspect of the invention, there is provided a ground support assembly for different pole structures, comprising:
a. a substantially planar base member, extending between a first end portion and a second end portion along a longitudinal central axis and defining a top surface and a bottom surface, comprising a central support portion adapted to receive and support a predetermined range of different foot portions of different pole structures, and
b. a locking mechanism, adapted to releasably secure a foot portion of the predetermined range of different foot portions of the pole structure, comprising a first jaw member and an axially opposing second jaw member, each one selectively slidably mounted to said top surface of said base member and adapted to move in a direction along said central longitudinal axis between a first position, moved towards and enclosingly engaging said central support portion in cooperation with the other one of said first and second jaw member, and a second position, moved away and enclosingly disengaged from said central support portion;

wherein said second position is defined by a first and second stop member, each one operably coupled to said base member so as to stoppingly engage with a respective one of said first and second jaw member when moving from said first position towards said second position.

This provides the advantage that a single ground support plate can be made compatible for a variety of different support legs or poles with different feet designs or dimensions (e.g. from different manufacturers) via the selectively adjustable locking mechanism (selectively lockable jaw members), while improving its ease of use and durability. In particular, the stop members prevent the slidably movable jaw members from disengaging (i.e. dislodging from the guide rails) with the base plate when moved from the first (i.e. closed) position to the second (i.e. open) position, for example, when adjusting the locking mechanism for a different foot shape or size of a support leg, or simply opening the jaw members to remove the foot portion of the support leg. When repeatedly opening the jaws of the locking mechanism with a swift and suitably quick motion, the risk of derailing the jaw members is relatively high and the stop members ensure the correct operation by the user, thus, improving ease of use.

Advantageously, said central support portion is adapted to retainingly receive an adapter member configured to mountingly receive and support a predetermined foot portion of a pole structure.

This provides the advantage of improved adaptability to a wider range of different foot portions of the support legs and poles without having to change the whole ground support assembly.

Preferably, said central support portion is provided by a recess in said top surface of said base member.

Advantageously, each one of said first and second stop member is resiliently deflectable with respect to said base member. Preferably, each one of said first and second stop member comprises a cam follower portion adapted to contactingly engage with a corresponding cam surface of respective said first and second jaw member, so as to resiliently deflect out of stopping engagement with respective said first and second jaw member when moving towards said first position from a demounted position. Even more preferably, said cam surface of said first and second jaw member is an inclined surface with respect to said top surface of said base member facing towards said central portion during use.

This provides the advantage that the otherwise unremovable jaw members (i.e. to prevent the derailing during use), can be removed (e.g. for repair or replacement) by a simple user action (i.e. depressing the stop members), and moved back into the retaining guide rails of the base plate and the confinement provided by the stopper members without any additional user action (i.e. the stop member is depressed by the cam follower engaging with the cam surface of the moving jaw member).

Advantageously, said base member further comprises a parallelly aligned first pair of toothed rack portions at said first end portion and a parallelly aligned second pair of toothed rack portions at said second end portion arranged coaxially with said first pair of toothed rack portions and said longitudinal central axis. Preferably, each one of said first and second pair of toothed rack portions is adapted to guidingly and centringly receive a respective one of said first and second jaw member.

Advantageously, the ground support assembly further comprises a first and second pair of cooperating locking pawls, each one removably coupled with a corresponding one of said first and second jaw member, adapted to selectively lockingly engage with a corresponding one of said first and second pair of toothed rack portions. Preferably, each one of said first and second pair of cooperating locking pawls is moveable between a locked position, lockingly engaged with a corresponding one of said first and second pair of toothed rack portions so as to prevent movement of a corresponding one of said first and second jaw member relative to said base member, and an unlocked position, lockingly disengaged with a corresponding one of said first and second pair of toothed rack portions so as to allow movement of a corresponding one of said first and second jaw member relative to said base member. Even more preferably, each one of said cooperating pair of locking pawls is biased towards said locked position.

This provides the advantage of a selectively actuatable unlocking of the otherwise locked jaw members (locked in a desired position along the toothed rack). In particular, the two cooperating locking pawls of each pair are operably coupled with a respective jaw member so as to lock the jaw member in a desired position along the toothed rack of the base member. Upon actuation (i.e. pressing the cooperating locking pawls of a jaw member), the jaw member can be moved along the central longitudinal axis of the base member until the locking pawls are released, at which point the locking pawls are automatically forced back into locking engagement with the toothed rack due to the bias provided by the spring member operably coupled between the cooperating locking pawls.

Advantageously, said first and second jaw member are adapted to intermeshingly engage with each other when moved into said first position (i.e. closed). Preferably, said first jaw member comprises at least one first projection and/or first recess, and said second jaw member comprises at least one second recess and/or second projection arranged complementary to and axially aligned with said first projection and/or first recess, during use. This provides the advantage of an improved stability and durability.

Advantageously, the ground support assembly further comprises at least one rib member provided at said bottom surface of said base member configured to provide a predetermined distance between said top surface and the ground, during use.

Advantageously, any one of said base member, said first and second jaw members, said first and second pair of locking pawls and said adapter plate are made from a polymer material.

### BRIEF DESCRIPTION OF THE DRAWINGS

An exemplary embodiment of the invention is explained in more detail hereinbelow with reference to the figures:

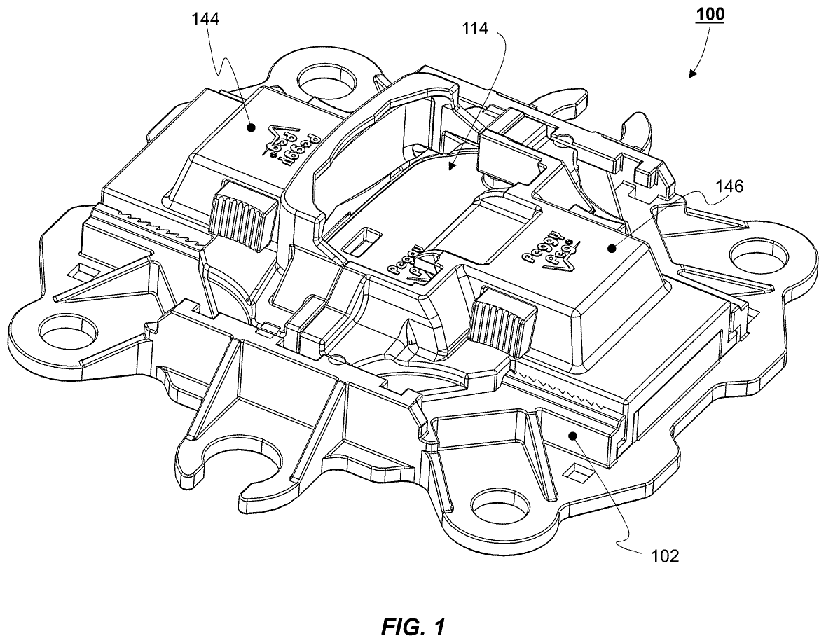

a. FIG. 1 illustrates a perspective top view of an example embodiment of the ground support assembly of the present invention in a closed configuration;

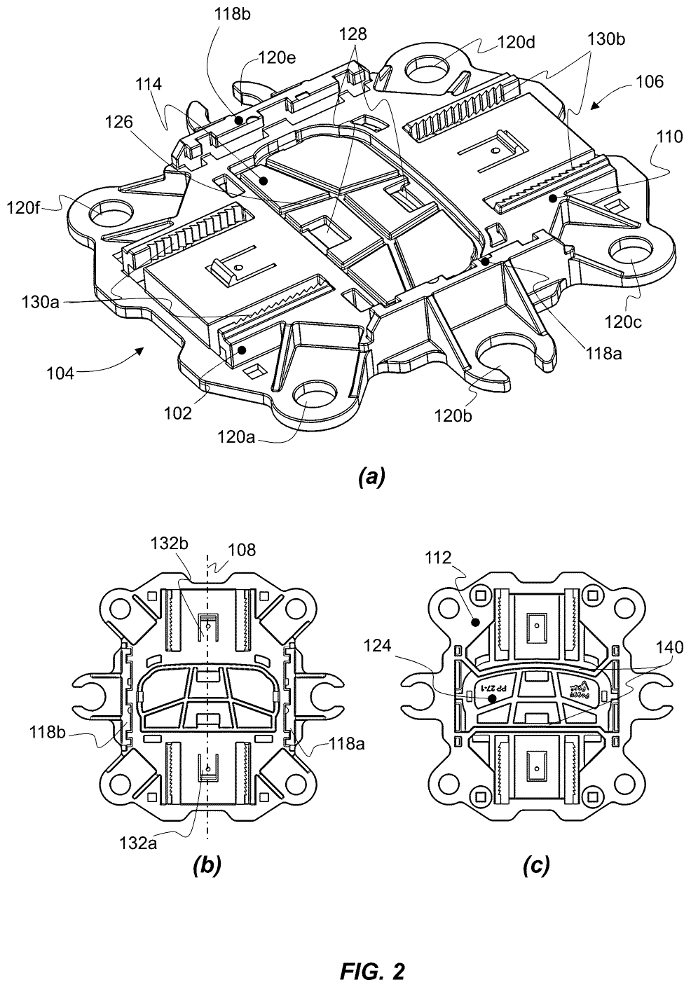

b. FIG. 2 illustrates the base plate of the ground support assembly of FIG. 1, without the locking jaws (jaw members) and adapter plate in (a) a perspective top view, (b) a top view and (c) a bottom view;

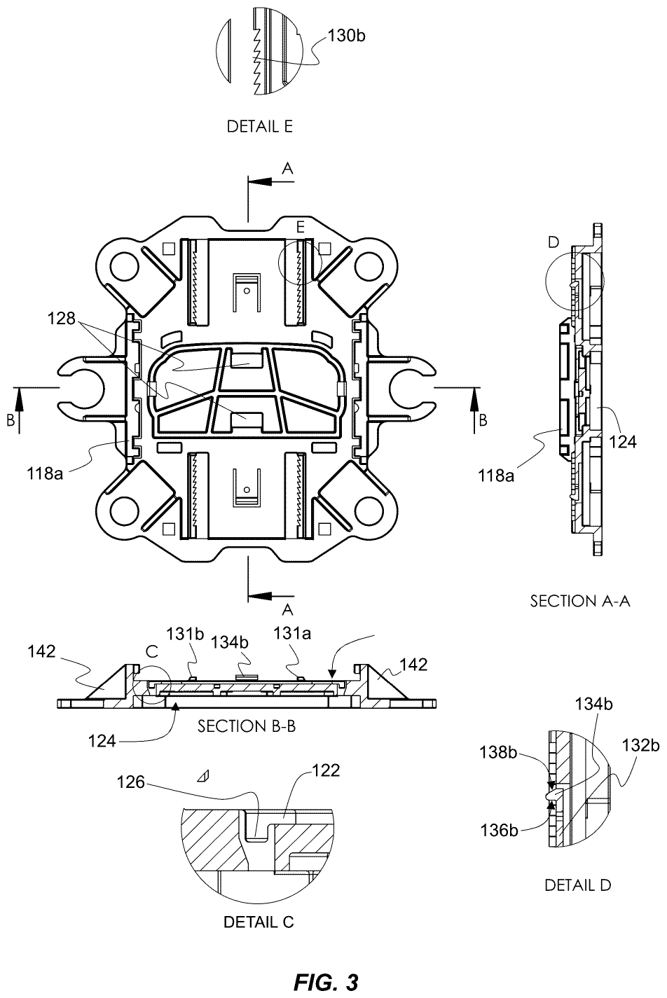

c. FIG. 3 illustrates a top view, cross sectional views and detailed views of the base member in FIG. 2;

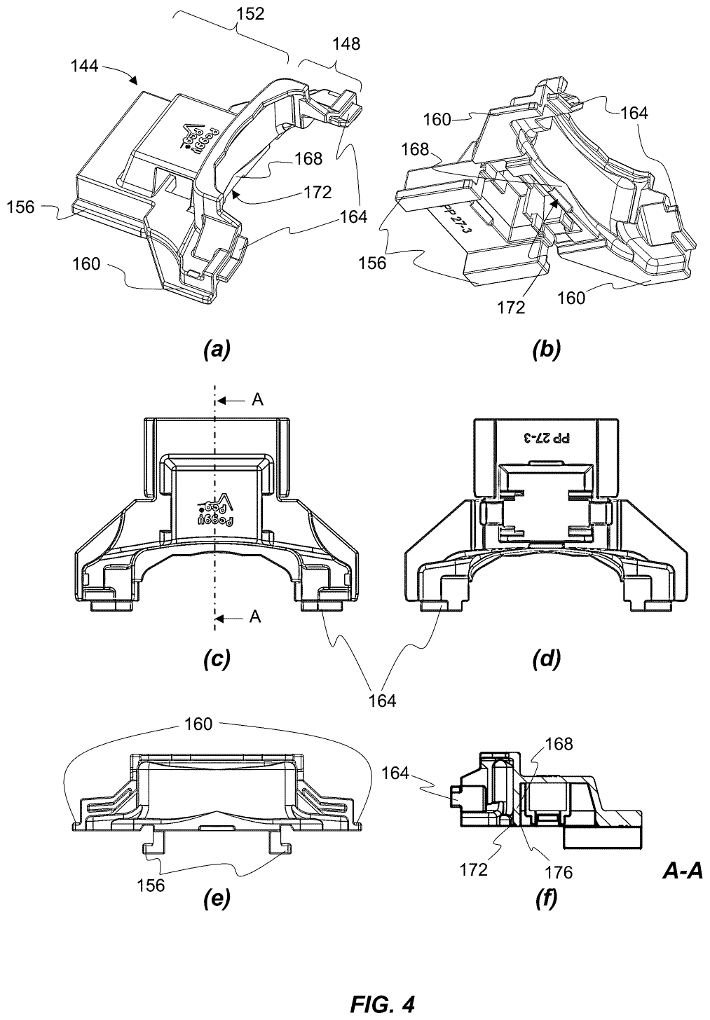

d. FIG. 4 illustrates the first locking jaw (jaw member) of the ground support assembly of FIG. 1 in (a) a perspective top view, (b) a perspective bottom view, (c) a top view, (d) a bottom view, (e) a front view and (f) a cross-sectional side view along A-A;

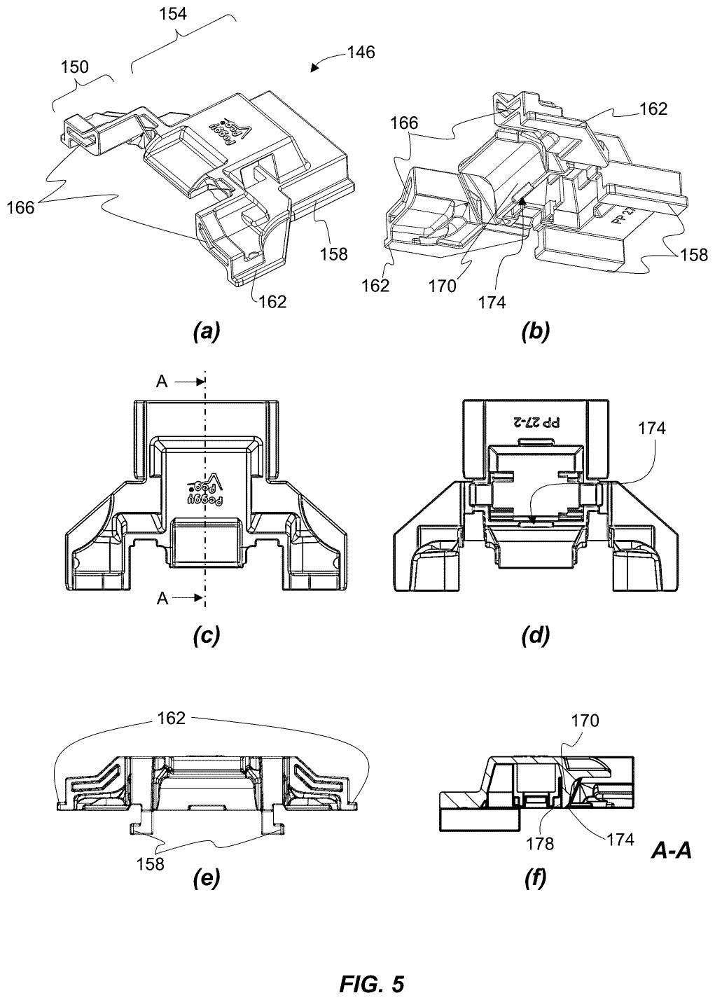

e. FIG. 5 illustrates the second locking jaw (jaw member) of the ground support assembly of FIG. 1 in (a) a perspective top view, (b) a perspective bottom view, (c) a top view, (d) a bottom view, (e) a front view and (f) a cross-sectional side view along A-A;

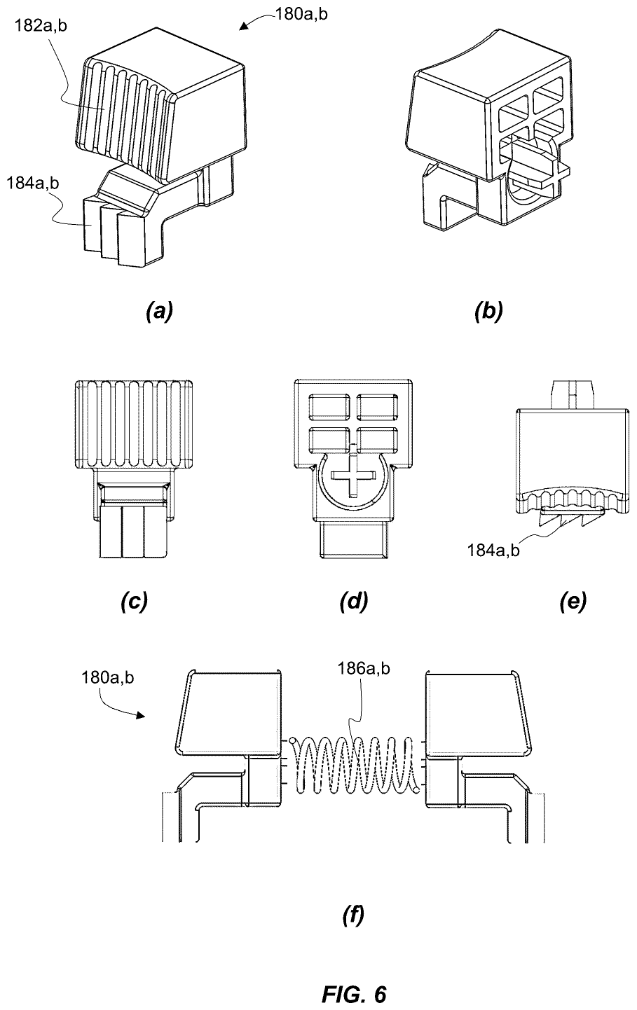

f. FIG. 6 illustrates a locking pawl of the ground support assembly of FIG. 1 in (a) a perspective front view, (b) a perspective rear view, (c) a front view, (d) a rear view, (e) a top view and (f) a schematic side view of a cooperating pair of locking pawls operably coupled by a spring member;

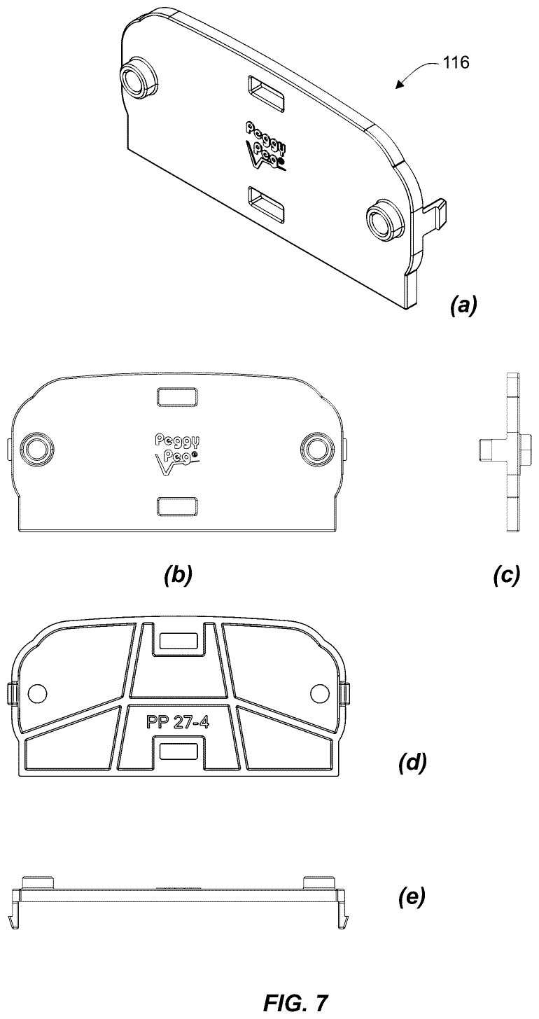

g. FIG. 7 illustrates an adapter plate of the ground support assembly of FIG. 1 in (a) a perspective view, (b) a top view, (c) a side view, (d) a bottom view and (e) a front view;

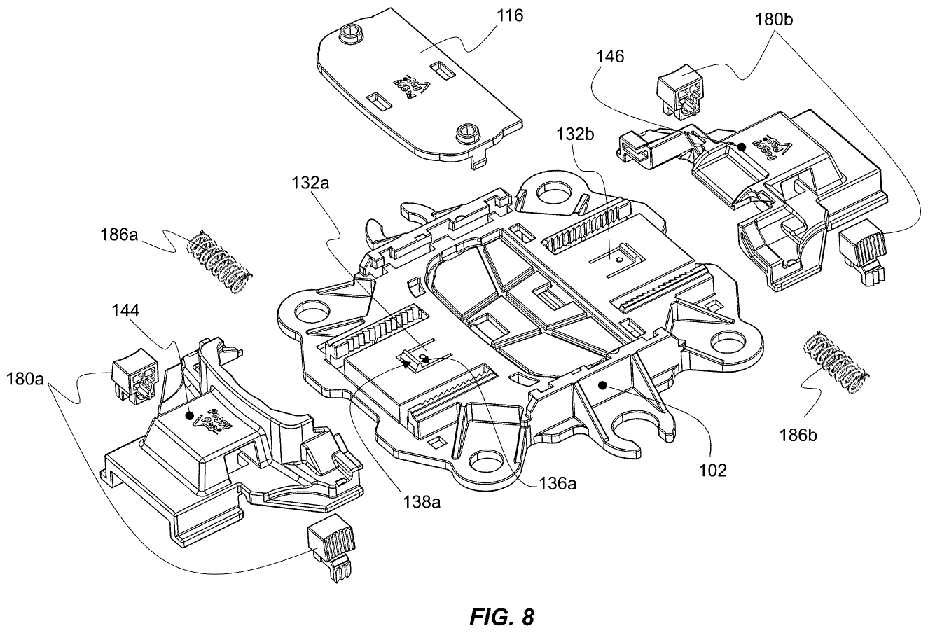

h. FIG. 8 illustrates an exploded perspective top view of the ground support assembly of FIG. 1;

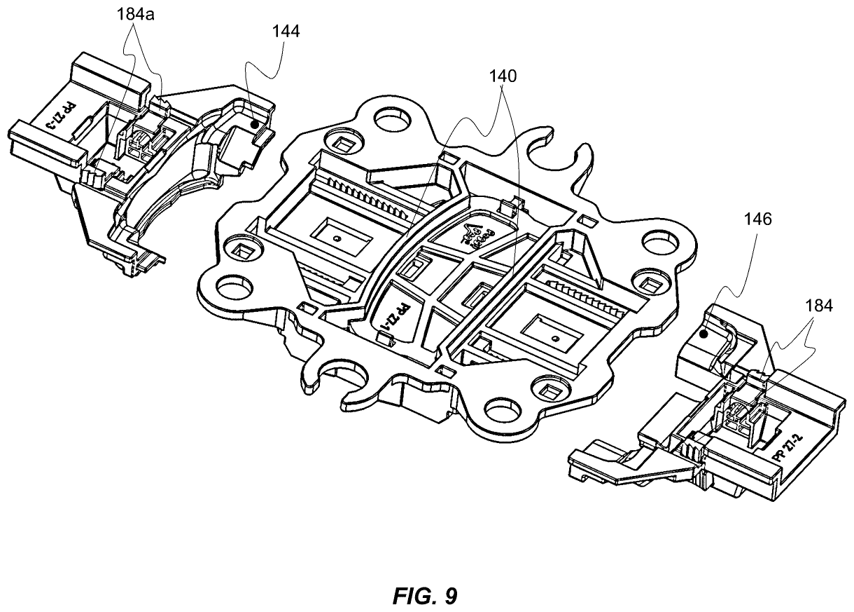

i. FIG. 9 illustrates a partially exploded perspective bottom view of the ground support assembly of FIG. 1;

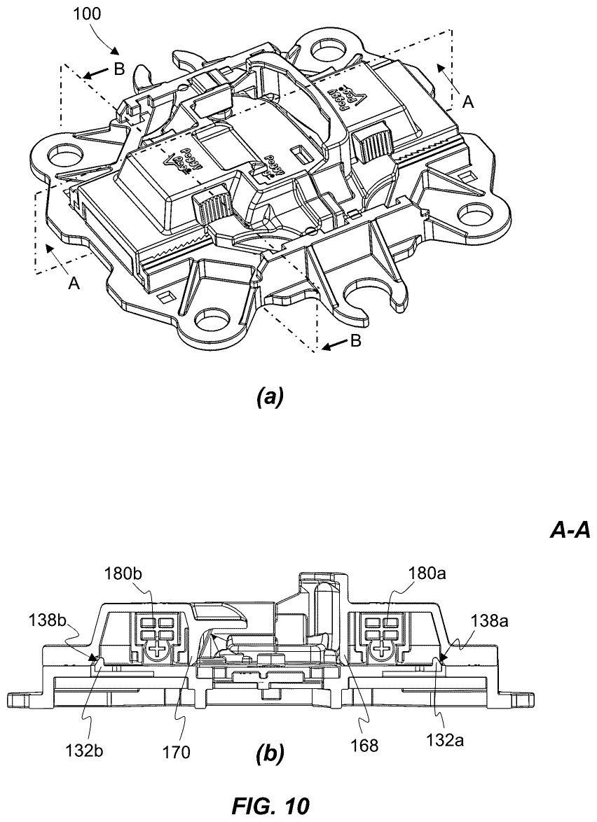

j. FIG. 10 illustrates (a) a perspective top-side view of the closed ground support assembly of FIG. 1 including adapter plate, and (b) a cross-sectional side-view along sectional plane A-A;

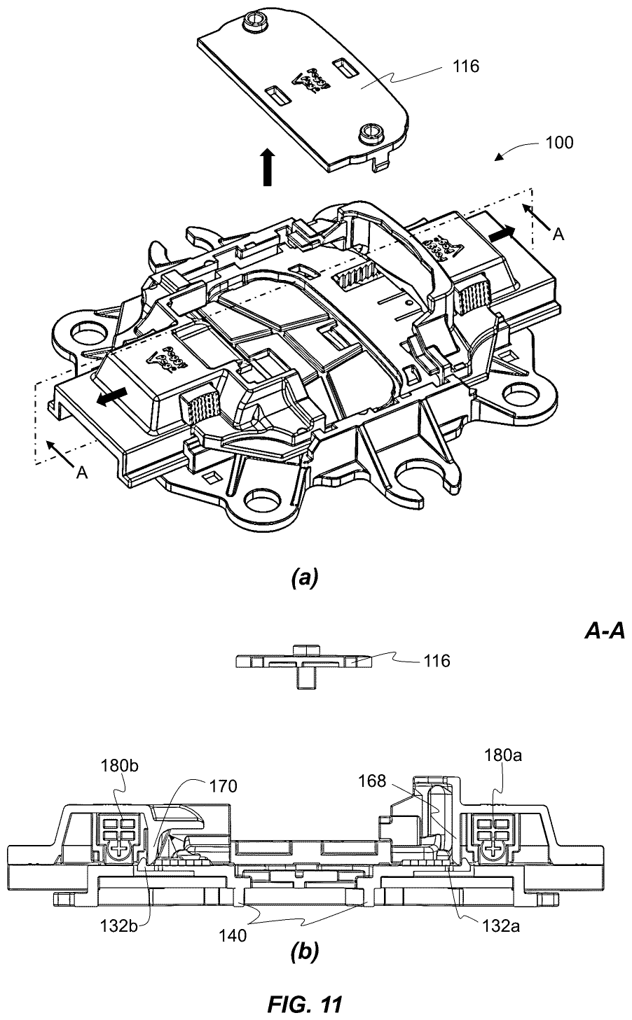

k. FIG. 11 illustrates (a) a schematic perspective top-side view (arrows indicating the movement of the jaws and adapter plate) of the ground support assembly of FIG. 1 with the adapter plate moved out of the central support portion, and (b) a cross-sectional side-view along sectional plane A-A;

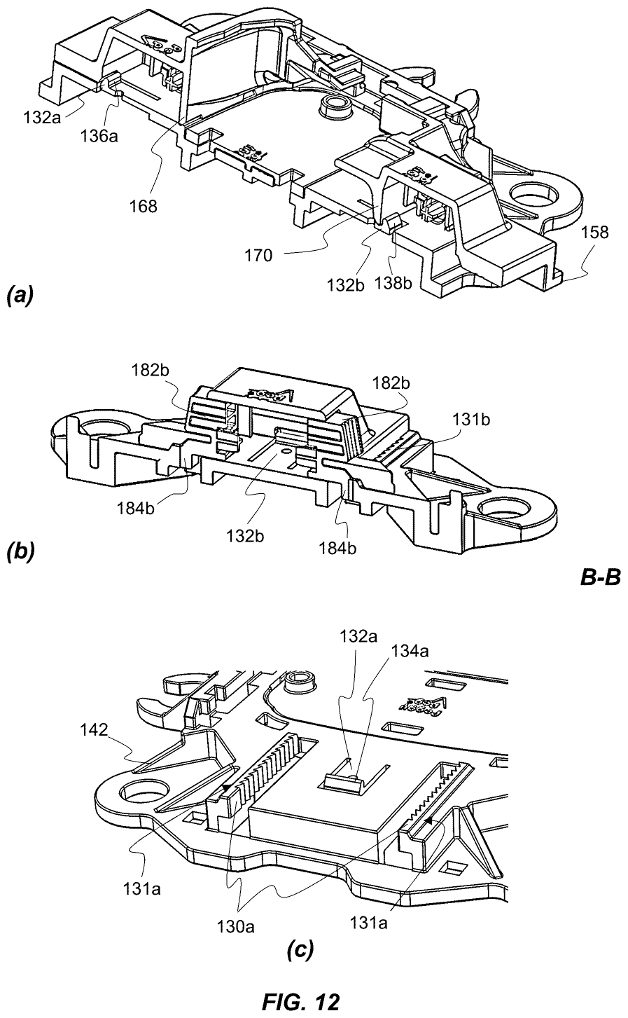

l. FIG. 12 illustrates (a) a cross-sectional side-view along sectional plane A-A of FIG. 10(a), (b) a cross-sectional side-view along sectional plane B-B of FIGS. 10(a), and (c) a partial close-up view of the toothed rack provided on the base plate, and

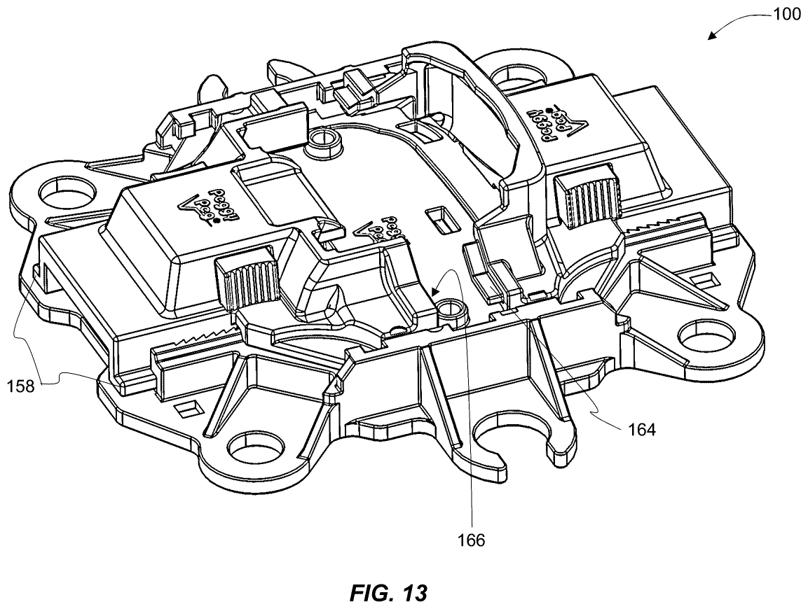

m. FIG. 13 illustrates a perspective top-side view of the ground support assembly of FIG. 1 in a partially open configuration.

### DETAILED DESCRIPTION

The described example embodiment relates to a ground support assembly for support legs or support poles of an awning or tent-like structure. In particular, the described example embodiment is described in relation to a rollout awning for caravans or vehicles utilising support legs with dedicated foot portions. However, the invention is not limited to support legs or poles for awnings and may also be used for any support structure of a temporary shelter utilising suitable foot portions.

Certain terminology is used in the following description for convenience only and is not limiting. The words ‘right’, ‘left’, ‘lower’, ‘upper’, ‘front’, ‘rear’, ‘upward’, ‘down’, ‘downward’, ‘above’ and ‘below’ designate directions in the drawings to which reference is made and are with respect to the described component when assembled and mounted (e.g. in situ). In particular, the designated directions used in the description are with respect to the ground support assembly when coupled to a foot portion of a support leg and placed on the ground in an upright position. It is understood that the ground support assembly may be used in any other orientation suitable to fixedly and supportingly couple with a foot portion of a support leg. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

Through the description and claims of this specification, the terms ‘comprise’ and ‘contain’, and variations thereof, are interpreted to mean ‘including but not limited to’, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality, as well as, singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

Furthermore, the terms support legs, support poles, legs or poles are used interchangeably and are merely examples of possible support structures having at least one foot portion suitable for coupling with the support assembly of the present invention.

Referring now to FIGS. 1 to 3, an example embodiment of an assembled ground support assembly 100 is shown in a closed configuration. The basic components of the ground support assembly 100 include a base member 102 having a central support portion 114, and two cooperatingly opposing jaw members, i.e. a first jaw member 144 and a second jaw member 146, each one slidably movably coupled to the top surface 110 of the base member 102. Optionally, an adapter plate 116 can be mounted within the central support portion 114.

With particular reference to FIG. 2, the base member 102 is provided by a substantially planar plate extending along a central longitudinal axis 108 between a first end portion 104 and a second end portion 106 and forming a top surface 110 and a bottom surface 112. Two opposing guide rails 118a,b are provided at the lateral edges of a mid section of the base member 102. Respective apertures 120a-f are provided at each corner section, as well as, laterally extending side sections of the base member 102. The apertures 120a-f are configure to receive suitable pegs, nails or screws, so as to secure the base member to the ground.

The main platform (i.e. top surface 110) of the base member 102 is raised with respect to the corner- and side sections of the base member 102 comprising the apertures 120a-f (e.g. through injection moulding during manufacture) forming respective recess(es) at the bottom surface 112 of the base member 102. The central support portion 114 is provided by a uniquely shaped recess in a central region of the top surface 110 of the base member 102. In particular, the central support portion 114 may include patterned grooves 126 and through holes 128 suitable to retainingly receive lockingly attach an adapter plate 116.

A first and second pair of parallelly aligned toothed rack portions 130a, b is provided at the first end portion and the second end portion 104, 106 of the base member 102, respectively. In particular, each individual toothed rack portion of the first and second pair of toothed rack portions 130a, b is “slotted” into the raised main platform (top surface 110) of the base member 102 forming an elongated aperture through the base member 102 that is configured to provide a guide slot for a suitable locking pawl (from a pair of locking pawls 180a,b, described in a later section). Further, each one of the first and second pair of toothed rack portions 130a,b is projecting past the top surface 110 of the main platform, so as to form a pair of first and second guide rails 131a,b. The laterally outward facing edge of each one of the guide rails 131a,b is bevelled such that a cooperating pair of guide rails forms a centring glide surface.

A resilient first and second stop member 132a,b is provided centrally between each pair of toothed rack portions 130a,b. The first and second stop members 132a,b are “cut” (e.g. through injection moulding during manufacture) into the base member 102, so as to form a deflectable catch with a substantially upright projection 134a,b at its deflectable end (i.e. extending away from the top surface 110). In this particular example, the deflectable end of the first and second stop member 132a,b is aligned towards respective first and second end portion 104, 106 of the base member 102. The projection 134a,b of the first and second stop member 132a,b comprises a stopping surface 136a,b (respective first and second), substantially perpendicular with respect to the top surface 112 and facing towards the central support portion 114, and a release surface 138a,b (respective first and second), inclined with respect to the top surface 110 and facing towards the first and second end portion 104, 106, respectively.

As shown in particular in FIG. 2(c), the recessed bottom surface 112 of the base member 102 is provided with two central rib members 140 arranged transversely to the central longitudinal axis 108 outlining the footprint defined by the recessed central support portion 114. Supporting ribs 142 extend from the raised main platform laterally out and down towards the peg apertures 120a-f, so as to strengthen the structure of the base member 102.

Additional apertures (not shown in detail) are provided through the base member 102 to minimise the weight of the ground support assembly 100, but also to provide passages for dirt and water to pass through and away from the moving parts, during use.

Referring now to FIGS. 4 and 5, a first jaw member 144 and a second jaw member 146 are shown individually. Each one of the first and second jaw members 144, 146 comprises a rear portion 152, 154, pointing to an end portion 104, 106 of the base member 102, and a front portion 148, 150, pointing towards the central support portion 114, during use.

The rear portion 152, 154 comprises a first pair of lateral rims 156, 158 adapted to operably engage (i.e. slidably) with respective guiding slots of the first or second pair of toothed rack portions 130a,b. In particular, the cross section of the guiding slots formed by the pair of two other rack portions 130a,b is configured to slidingly and retainingly receive respective first pair of lateral rims 156, 158 of the rear portion 152, 154 of the first and second jaw member 144, 146.

The front portion 148, 150 comprises a second pair of lateral rims 160, 162 adapted to operably engage with the guide rails 118a,b of the base member 102, thus, restricting relative movement of the first and second jaw members 144, 146 relative to the base member 102 along the central longitudinal axis 108 of the base member 102.

The first and second front portions 148, 150 of each one of the first and second jaw members 144, 146 are formed complementary to each other, so as to retainingly enclose a predetermined range of foot portions of the support leg or pole when moved into the closed position. Particular examples of suitable shapes are illustrated in FIGS. 4 and 5, however, it is understood by the person skilled in the art, that any other suitable shape may be used to retainingly enclose a particular foot portion of a support leg.

A first and second cam member 168, 170 is provided at a wall portion dividing the front portion 148, 150 and the rear portion 152, 154 of respective first and second jaw members 144, 146. Each one of the first and second cam members 168, 170 comprises a forward facing cam surface 172, 174 and a rearward facing stop surface 176, 178, relative to the movement of the jaw member 144, 146 from the open, i.e. rear position, to the closed, i.e. forward position, during use. The cam surface 172, 174 is configured to operably engage with the release surface 138a,b of respective first or second stop member 132a,b, such that the projection 134a,b of respective first or second stop member 132a,b operates as a cam follower with cam surface 172, 174 in order to deflect the stop member 132a,b out of engagement with respective first or second jaw member 144, 146, during assembly. When assembled, the stop surface 176, 178 of the first and second cam member 168, 170 is configured to stoppingly engage with the stopping surface 136a,b of respective first and second stop member 132a,b, thus, preventing the jaw member 144, 146 from moving out of engagement with the base member 102, during normal use. In the event that a jaw member needs to be removed, the resiliently deflectable stop member 132a,b is simply moved out of engagement (e.g. pressed into the bottom recess 124 by the user) while pulling the jaw member 144, 146 out of respective guide rails 118a,b and 131a,b and the toothed rack portion.

In addition, the first front portion 148 may be equipped with one or more tooth members 164 protruding axially away from the first front portion 148 (i.e. towards the opposing second front portion 150, during use). In this particular example, a pair of contoured tooth members 164 are provided on either side of the first front portion 148. The second front portion 150 may comprise respectively contoured recesses 166 arranged so as to matingly or intermeshingly engage with the contoured tooth members 164, thus, providing a secure and stable enclosure when first and second jaw members 144, 146 are moved into the closed position. It will be understood by the person skilled in the art, that any suitable configuration may be used for the first and second front portion 148, 150 to intermeshingly or matingly lock the first and second jaw member 144, 146 when moved into the closed position (see also FIG. 10(b) and FIG. 13).

Referring now to FIGS. 6(a) to (f) and FIG. 8, a pair of locking pawls 180a,b is operably mounted to the first and second jaw member 144, 146, and configured to selectively release and lock the first and second jaw members 144, 146, during use. In particular, each one of the locking pawls 180a,b comprises a button portion 182a,b, configures for gripping and pushing by the user, and a rack engagement portion 184a,b, configured for locking engagement with the toothed rack portion 130a,b. When assembled, a pair of locking pawls 180a,b is provided on opposing lateral sides of and operably coupled with a respective jaw member 144, 146, such that the button portion 182a,b projects out of respective lateral apertures of the rear portion 152, 154 of respective first and second jaw members 144, 146, and the rack engagement portion 184a,b, intermeshingly engages with a respective toothed rack portion 130a,b. Each one of the locking pawls 180a,b is movable between a locked position, lockingly engaged with the toothed rack portion 130a,b and an unlocked position, disengaged from the toothed rack portion 130a,b. Each one of the locking pawls 180a,b, is biased towards its locked position by a spring member 186a,b operably coupled between two cooperating locking pawls 180a,b. For example, a coil spring 186a,b, is mounted to suitable protrusions of two opposing locking pawls 180a,b, joining the locking pawls 180a,b and providing a bias to push each one of the opposing locking pawls 180a,b into its locked position.

The intermeshingly engaging teeth of respective toothed rack portion 130a,b of the base member 102 and rack engagement portion 184a,b of the locking pawl 180a,b may be configured to allow movement of the first and second jaw member 144, 146 from its open position towards its closed position without actuating the pair of locking pawls 180a,b (i.e. pressing the opposing button portions 182a,b so as to disengage the rack engagement portion from the toothed rack portion 130a,b), while preventing movement of the first and second jaw member 144, 146 from its closed position towards its open position without disengaging the locking pawls 180a,b, from respective toothed rack portions 130a,b. In particular, both set of teeth may be shaped (asymmetric) so as to provide a sliding ratchet mechanism between the biased rack engagement portion 184a,b of the locking pawls 180a,b, and the toothed rack portion 130a,b of the base member 102. However, it is understood by the person skilled in the art, that any suitable selectively actuatable locking mechanism may be used to selectively move and lock the first and second jaw member 144, 146.

Referring now to FIG. 7, an adapter plate 116 may be provided to be mounted into the central support portion 114 of the base member. In this particular example, the adapter plate 116 may be mounted to the central support portion 114 via a snap-fit suitable to lockingly engage with respective apertures of the central support portion 114. Snap-fit mechanism are well known in the art and are not described in any more detail. The adapter plate 116 may comprise predetermined structural features such as contours, apertures, projections etc. specific for a particular foot portion of a support structure or leg, thus, adapter plates 116 with predetermined structural features may be used for different foot portions of a particular support structure or leg.

Referring now to FIGS. 8 to 13, in particular, the assembly and use of this particular example embodiment of the ground support assembly 100 of the present invention is described. However, it is understood by the person skilled in the art, that the particular steps to assemble and use of other embodiments of the ground support assembly 100 of the present invention may vary.

In order to assemble a previously disassembled ground support assembly 100, the first and second pair of lateral rims 156, 158, 160, 162 of the first and second jaw member 144, 146 are simple moved into respective guide rails 118a,b the toothed rack portion slots 130a,b of the base member 102 to then slide the first and second jaw member 144, 146 forward (i.e. towards the central support portion 114). The sliding ratchet configuration between the toothed rack portion 130a,b and respective rack engagement portion 184a,b allows movement of the jaw member 144, 146 without having to actuate the locking pawls 180a,b. When moving the jaw member 144, 146 into engagement with the projection 134a,b of the stop member 132a,b, the first and second cam member 168, 170 of respective first and second jaw member 144, 146 unlockingly deflect the stop member 132a,b allowing the forward moving jaw members 144, 146 to move towards the central support portion 114. Once the cam member 168, 170 has passed the stop member 132a,b the ground support assembly 100 is ready for use (see cross-section in FIG. 12(a)). FIG. 9 shows the ground support assembly 100 from the bottom with the jaw members 144, 146 decoupled from the base member 102. FIGS. 10 and 11 show the ground support assembly 100 in respective closed and open position (with the adapter plate 116 removed).

During use, a ground support assembly 100 is simply placed on the ground and the first and second jaw members 144, 146 are moved into respective open positions. Pegs, nails or screws may be pushed or screwed through the peg apertures 129a-f so as to secure the ground support assembly 100 to the ground (e.g. grass surface). A foot portion of a support leg (e.g. for an awning or any other tent-like structure) is then placed into the central support portion 114 and the jaw members 144, 146 are simply moved (without having to press and unlock the locking pawls 180a,b) into respective closed positions, so as to retainingly enclose the foot portion, thus, securing the support leg of the awning to the ground. The enclosure of the closed jaw members 144, 146 is strengthened by the intermeshing between the first 144 and second jaw member 146.

If required, an adapter plate 116 may be fitted into the central support portion 114 so as to accommodate other shapes of the support structures or legs. The raised main platform of the top surface 110 and bottom recesses 124 provide a predetermined distance between the moving components and the ground preventing or at least minimising possible ingress of dirt, sand and moisture. Also, suitable holes, recesses and grooves provided in the base member 102 allow easy removal of dirt and moisture, if required.

For a quick and easy removal of the foot portion of the support structure or leg (e.g. from an awning or tent-like structure), the user simply actuates a respective pair of locking pawls 180a,b, i.e. by pressing opposing button portions 182a,b and disengaging the rack engagement portions 184a,b from respective toothed rack portions 130a,b, to then move the jaw members 144, 146 back to the open position (see also cross-section of FIG. 12(b)). The stop members 132a,b will prevent the user from accidentally moving the jaw members 144, 146 out of engagement with the base member 102, so there is no need for the user to check the exact position of the jaw members 144, 146, saving precious time and potential damage.

Further, the wear or risk of potential damage of any of the moving parts of the present invention is likely to be highest with the locking pawls 180a,b (locking pawl and spring member 186a,b). The modularity of the pair of locking pawls 180a,b allows for simple and easy replacement without having to replace the whole ground support assembly 100, thus, saving costs and resources, as well as, minimising waste.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible, for example, variations may exist in shape, size, arrangement (i.e. a single unitary components or two separate components), assembly or the like.

### REFERENCE NUMERALS LIST

100 ground support assembly
102 base member
104 first end portion
106 second end portion
108 central longitudinal axis
110 top surface
112 bottom surface
114 central support portion
116 adapter plate
118a,b guide rails
120a-f peg apertures
122 top recess
124 bottom recess(es)
126 grooves
128 through holes
130a, b 1st, 2nd toothed rack portion
131a,b 1st, 2nd guide rails
132a,b 1st, 2nd stop member
134a,b projection
136a,b stopping surface
138a,b release surface
140 central rib members
142 supporting ribs
144 1st jaw member
146 2nd jaw member
148 1st front portion
150 2nd front portion
152 1st rear portion
154 2nd rear portion
156 1st pair of lateral rims
158 1st pair of lateral rims
160 2nd pair of lateral rims
162 2nd pair of lateral rims
164 contoured tooth member
166 contoured recess
168 1st cam member
170 2nd cam member
172 1st cam surface
174 2nd cam surface
176 1st stop surface
178 2nd stop surface
180a,b pair of locking pawls
182a,b button portion
184a,b rack engagement portion
186a,b spring member

1. A ground support assembly for different pole structures, comprising:
a substantially planar base member, extending between a first end portion and a second end portion along a longitudinal central axis and defining a top surface and a bottom surface, comprising a central support portion adapted to receive and support a predetermined range of different foot portions of different pole structures, and
a locking mechanism, adapted to releasably secure a foot portion of the predetermined range of different foot portions of the pole structure, comprising a first jaw member and an axially opposing second jaw member, each one selectively slidably mounted to said top surface of said base member and adapted to move in a direction along said central longitudinal axis between a first position, moved towards and enclosingly engaging said central support portion in cooperation with the other one of said first and second jaw member, and a second position, moved away and enclosingly disengaged from said central support portion;
wherein said second position is defined by a first and second stop member, each one operably coupled to said base member so as to stoppingly engage with a respective one of said first and second jaw member when moving from said first position towards said second position.

2. A ground support assembly according to claim 1, wherein said central support portion is adapted to retainingly receive an adapter member configured to mountingly receive and support a predetermined foot portion of a pole structure.

3. A ground support assembly according to claim 2, wherein said central support portion is provided by a recess in said top surface of said base member.

4. A ground support assembly according to claim 1, wherein each one of said first and second stop member is resiliently deflectable with respect to said base member.

5. A ground support assembly according to claim 4, wherein each one of said first and second stop member comprises a cam follower portion adapted to contactingly engage with a corresponding cam surface of respective said first and second jaw member, so as to resiliently deflect out of stopping engagement with respective said first and second jaw member when moving towards said first position.

6. A ground support assembly according to claim 5, wherein said cam surface of said first and second jaw member is an inclined surface with respect to said top surface of said base member facing towards said central portion during use.

7. A ground support assembly according to claim 1, wherein said base member further comprises a parallelly aligned first pair of toothed rack portions at said first end portion and a parallelly aligned second pair of toothed rack portions at said second end portion arranged coaxially with said first pair of toothed rack portions and said longitudinal central axis.

8. A ground support assembly according to claim 7, wherein each one of said first and second pair of toothed rack portions is adapted to guidingly and centringly receive a respective one of said first and second jaw member.

9. A ground support assembly according to claim 7, further comprising a first and second pair of cooperating locking pawls, each one removably coupled with a corresponding one of said first and second jaw member, adapted to selectively lockingly engage with a corresponding one of said first and second pair of toothed rack portions.

10. A ground support assembly according to claim 9, wherein each one of said first and second pair of cooperating locking pawls is moveable between a locked position, lockingly engaged with a corresponding one of said first and second pair of toothed rack portions so as to prevent movement of a corresponding one of said first and second jaw member relative to said base member, and an unlocked position, lockingly disengaged with a corresponding one of said first and second pair of toothed rack portions so as to allow movement of a corresponding one of said first and second jaw member relative to said base member.

11. A ground support assembly according to claim 10, wherein each one of said cooperating pair of locking pawls is biased towards said locked position.

12. A ground support assembly according to claim 1, wherein said first and second jaw member are adapted to intermeshingly engage with each other when moved into said first position.

13. A ground support assembly, according to claim 12, wherein said first jaw member comprises least one first projection and/or first recess, and said second jaw member comprises at least one second recess and/or second projection arranged complementary to and axially aligned with said first projection and/or first recess, during use.

14. A ground support assembly according to claim 1, further comprising at least one rib member provided at said bottom surface of said base member configured to provide a predetermined distance between said top surface and the ground, during use.

15. A ground support assembly according to claim 1, wherein any one of said base member, said first and second jaw members, said first and second pair of locking pawls and said adapter plate are made from a polymer material.
